(19) United States
(12) Patent Application Publication
(10) Pub. No.: US 2010/0165614 A1
(43) Pub. Date: Jul. 1, 2010

(54) LED LAMP AND MANUFACTURING METHOD THEREOF

(75) Inventors: JER-HAUR KUO, Tu-Cheng (TW); XIN-XIANG ZHA, Shenzhen City (CN); LIN YANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/494,308

(22) Filed: Jun. 30, 2009

(30) Foreign Application Priority Data
Dec. 25, 2008 (CN) 200810306534.1

(51) Int. Cl. F21V 21/00; F21V 9/00; H01J 9/00

(52) U.S. Cl. 362/217.01; 362/227; 362/231; 445/26

(57) ABSTRACT

An LED lamp comprises a lamp enclosure and an LED assembly. The lamp enclosure defines a receiving hole therein, and the LED assembly is received in the lamp enclosure. The lamp enclosure is made of a light penetrable material. A plurality of fluorescent powders are doped integrally and distributed uniformly in the lamp enclosure. The LED assembly comprises a plurality of LEDs. Lights emitted by the LEDs pass through the lamp enclosure for lightening an outside of the LED lamp. A method for manufacturing the lamp is also disclosed.

### BACKGROUND

1. Technical Field

The present disclosure relates to a light emitting diode (LED) lamp and a manufacturing method thereof.

2. Description of Related Art

As a new light source, light emitting diodes (LEDs) have several advantages over incandescent and fluorescent lamps, including energy-efficient, long life and environmentally friendly. A plurality of LEDs are often incorporated in a lamp enclosure to form an LED lamp. The LED lamp has a trend of substituting for the fluorescent lamp for a light purpose because of its high brightness. A conventional LED lamp includes a plurality of white LEDs. Each white LED includes a blue LED chip with a yellow fluorescent powder layer coated at an outer surface thereof. In operation of the LED lamp, a portion of the blue lights emitted by the blue LED chips activate the yellow fluorescent powder to emit yellow lights, and the yellow lights mix with the other portion of the blue lights to thereby obtain white lights. Since the LED chips are very small, the outer surfaces of the LED chips are too small to be coated with the yellow fluorescent powder layer thereon, a manufacturing process of the white LED is time-consuming and inconvenient, which increases a manufacturing cost of the LED lamp.

Therefore, there is a need in the art for an LED lamp which can overcome the described problems.

### BRIEF DESCRIPTION OF THE DRAWINGS

FIG. 1 is an assembled, isometric view of an LED lamp in accordance with an exemplary embodiment.

FIG. 2 is an exploded, isometric view of the LED lamp of FIG. 1.

FIG. 3 is an enlarged view of a circled portion III-III of FIG. 2.

FIG. 4 is a cross-sectional view of the LED lamp of FIG. 1, taken along a line IV-IV thereof.

### DETAILED DESCRIPTION

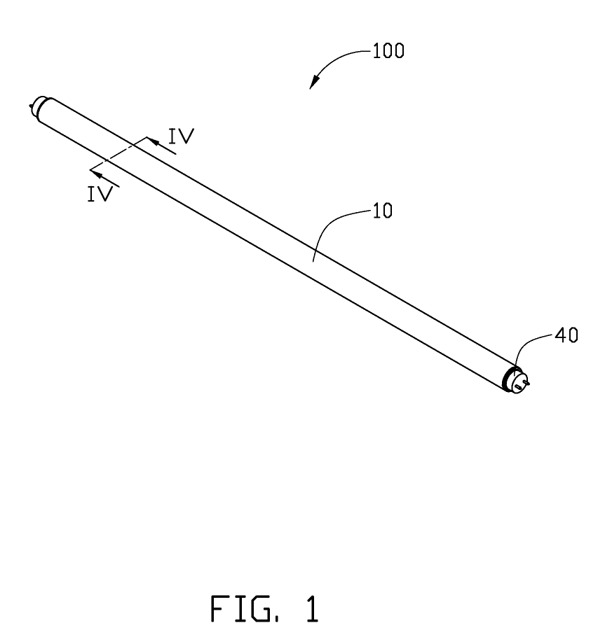

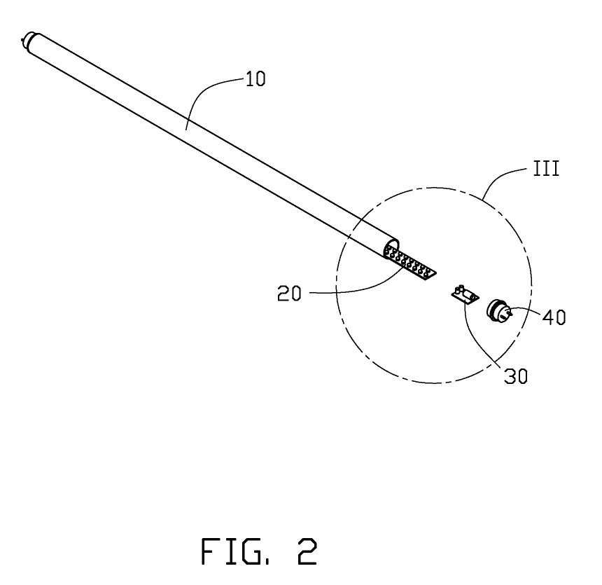

FIGS. 1 and 2 show an LED lamp 100 in accordance with an exemplary embodiment of the present disclosure. The LED lamp 100 includes an elongated, cylindrical (i.e., tubular) lamp enclosure 10, an LED assembly 20, a PCB (print circuit board) 30 and a power plug 40. The lamp enclosure 10 is hollow, and the LED assembly 20 and the PCB 30 are received in the lamp enclosure 10. The power plug 40 is mounted to one end of the lamp enclosure 10.

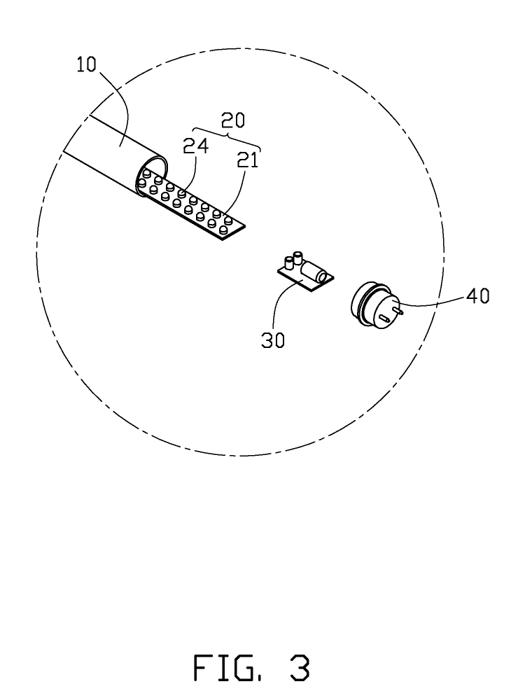

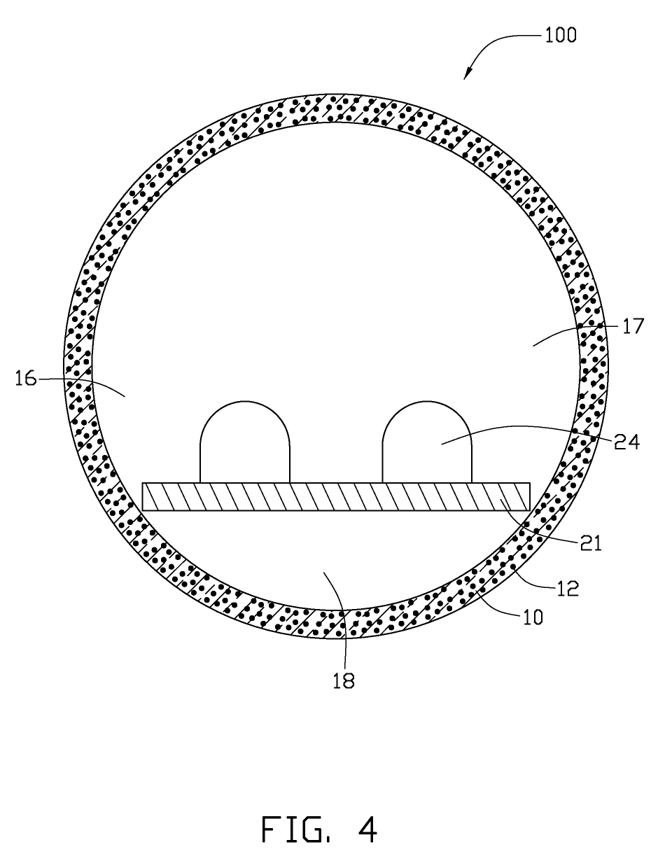

Referring to FIGS. 3-4, a receiving hole 16 surrounded by the lamp enclosure 10 is defined in the lamp enclosure 10. A thickness of the lamp enclosure 10 is uniform. The lamp enclosure 10 is made of light penetrable materials such as acryl, silicone, or epoxy resin. A plurality of fluorescent powders are uniformly doped and distributed in the lamp enclosure 10.

In a method of manufacturing the lamp enclosure 10, a transparent colloid, such as a melted acryl, silicone, or epoxy resin, is uniformly mixed with the fluorescent powders 12, such as yellow fluorescent powders. A mixture of the transparent colloid and the fluorescent powders 12 is injected into a mold. The lamp enclosure 10 with the fluorescent powders 12 uniformly distributed therein is thus formed after the mixture of the transparent colloid and the fluorescent powders 12 is solidified. Thus, the fluorescent powders 12 are integrally formed in the lamp enclosure 10.

The LED assembly 20 includes a substrate 21 and a plurality of LEDs 24 mounted on the substrate 21. The substrate 21 is made of a material having a good heat conductivity, such as aluminum. The substrate 21 is rectangular shaped. The substrate 21 is received in the receiving hole 16 of the lamp enclosure 10, and extends axially from an end of the lamp enclosure 10 towards another end of the lamp enclosure 10. The substrate 21 is located adjacent to a bottom of the lamp enclosure 10, such that the substrate 21 separates the receiving hole 16 into a wide upper chamber 17 above the substrate 21, and a narrow lower chamber 18 under the substrate 21. The upper chamber 17 of the receiving hole 16 is cooperatively enclosed by an upper side of the lamp enclosure 10 and the substrate 21. The lower chamber 18 of the receiving hole 16 is cooperatively enclosed by a lower side of the lamp enclosure 10 and the substrate 21. In this embodiment, the LEDs 24 are blue LEDs which emit blue lights, and the fluorescent powders 12 are yellow fluorescent powders. The LEDs 24 are arranged in a matrix on a top surface of the substrate 21 and protrude into the upper chamber 17 of the receiving hole 16 of the lamp enclosure 10, so that lights emitted from the LEDs 24 directly shoot towards the upper side of the lamp enclosure 10 and exit out of the LED lamp 100 via the upper side of the lamp enclosure 10. The upper side of the lamp enclosure 10 has a larger outer surface than the lower side of the lamp enclosure 10. Thus, the lights emitted from the LEDs 24 can advantageously leave the lamp enclosure 10 from the upper side of the lamp enclosure 10. The upper side of the lamp enclosure 10 functions as a light exit surface of the LED lamp 100.

The PCB 30 is received in one end of the receiving hole 16 of the lamp enclosure 10. The PCB 30 electrically connects with the LED assembly 20. The power plug 40 connects with one end of the lamp enclosure 10 and located adjacent to the PCB 30. The power plug 40 electrically connects the PCB 30 to an outside power supply. Thus, the PCB 30 can provide electrical current to the LEDs 24.

In operation of the LED lamp 100, blue lights emitted from the blue LEDs 24 are directed towards the lamp enclosure 10. When the blue lights pass through the lamp enclosure 10, a portion of the blue lights activate the yellow fluorescent powders 12 disposed in the lamp enclosure 10 to emit yellow lights, and then the yellow lights mix with the other portion of the blue lights to thereby obtain white lights. Then, the white lights are directed to outside for lightening purpose.

Since the yellow fluorescent powders 12 are mixed into the transparent colloid of the lamp enclosure 10 and integrally formed in the lamp enclosure 10, a manufacturing process of the LED lamp 100 is relatively simple and convenient. Furthermore, the thickness of the lamp enclosure 10 is uniform such that the white lights will not be dispersed into different kinds of colored lights due to prism effect.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp, comprising:
a lamp enclosure defining a receiving hole therein and being made of a light penetrable material, a plurality of fluorescent powders being integrally doped in the lamp disclosure and distributed uniformly in the lamp enclosure;
an LED assembly being received in the receiving hole of the lamp enclosure, the LED assembly comprising a plurality of LEDs, lights emitted by the LEDs passing through the lamp enclosure for lightening an outside of the LED lamp.

2. The LED lamp of claim 1, wherein the fluorescent powders are mixed in the light penetrable material when the light penetrable material is at a molten state, and integrally formed in the lamp enclosure.

3. The LED lamp of claim 1, wherein the LEDs are blue LEDs for generating blue light, and the fluorescent powders are yellow fluorescent powders for generating yellow light when incited.

4. The LED lamp of claim 1, wherein the LED assembly includes a substrate located adjacent to a bottom side of the lamp enclosure, so that the lamp enclosure forms a wide upper chamber above the substrate and a narrow lower chamber below the substrate, and the LEDs are located on the substrate and protrude into the upper chamber of the lamp enclosure.

5. The LED lamp of claim 1, wherein the lamp enclosure is elongated and cylindrical.

6. The LED lamp of claim 5, further comprising a PCB received in the receiving hole and a power plug mounted to one end of the lamp enclosure, the power plug being in electrical connection with the PCB and the PCB being in electrical connection with the LED assembly.

7. The LED lamp of claim 5, wherein the lamp enclosure has a uniform thickness.

8. A method of manufacturing an LED lamp, the method comprising:
melting a light penetrable material;
mixing a plurality of fluorescent powders uniformly in the melted light penetrable material to form a mixture;
using said mixture to form a lamp enclosure which defines a receiving hole therein;
disposing an LED assembly which includes a plurality of LEDs into the receiving hole of the lamp enclosure.

9. The method as claimed in claim 8, wherein the lamp enclosure is elongated and cylindrical, and has a uniform thickness.

10. The method as claimed in claim 8, wherein the fluorescent powders are yellow fluorescent powders which generate yellow light when incited, and the LEDs are blue LEDs which generate blue light when powered.
